(19) United States
(12) Patent Application Publication
(10) Pub. No.: US 2010/0201644 A1
(43) Pub. Date: Aug. 12, 2010

(54) INPUT PROCESSING DEVICE

(75) Inventor: Kazuhito OHSHITA, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/700,490

(22) Filed: Feb. 4, 2010

(30) Foreign Application Priority Data
Feb. 6, 2009 (JP) 2009-026601

(51) Int. Cl. G06F 3/041

(52) U.S. Cl. 345/173

(57) ABSTRACT

When a finger is moved in a circle along a curved path after being moved along a linear path in a first function region of an input surface of an input pad, vertical scrolling is continuously performed. When the finger is moved in a circle along another curved path after being moved along another linear path in a second function region, horizontal scrolling is continuously performed. By inverting the circling direction by an operation of the finger, the scrolling direction is switched to the reverse direction.

### CLAIM OF PRIORITY

This application claims benefit of the Japanese Patent Application No. 2009-026601 filed on Feb. 6, 2009, the entire contents of which is hereby incorporated by reference.

### BACKGROUND OF THE DISCLOSURE

1. Field of the Disclosure

The present invention relates to an input processing device that performs processing for moving displayed content displayed on a display device when an indicator in contact with a flat input pad is moved.

2. Description of the Related Art

Keyboards and computer mice are generally used as input processing devices equipped in personal computers. Moreover, in notebook-type personal computers, a flat input member having an input pad is used in combination with the keyboard. Conventional flat input members can be configured to detect a change in capacitance between electrodes when a low-potential indicator, such as a human finger, comes close to or into contact with the input pad. With this change in capacitance, coordinate data can be obtained. Based on this coordinate data obtained from the input member, a controller of the personal computer generates a control signal equivalent to that when a mouse, which is an external device, is operated.

In some recent personal computers, coordinate data can be input thereto by operating a tablet-type input device, which is provided over the display screen, by using a pen or a finger.

As discussed in Japanese Unexamined Patent Application Publications No. 2000-163031, 2000-163193, and 2001-265481, when a finger or the like is brought into contact with the flat input pad and is moved thereon, the input processing device of this type performs processing for moving the content display on a display device underlying the input pad or a display device provided at a separate location from the input pad in accordance with the moving direction of the finger.

In the input processing device of the related art, when a finger is brought into contact with the input pad and is moved thereon in one direction, the displayed content on the display device can be moved in conjunction with the finger in the moving direction thereof. However, when the finger is stopped or is moved away from the input pad, the processing for moving the displayed content is stopped, thereby stopping the image on the display device. Therefore, in order to move the displayed content continuously in the same direction, it is necessary to slide the finger repeatedly in the same region on the input pad.

These and other drawbacks exist.

### SUMMARY OF THE DISCLOSURE

Various examples disclosed herein provide an input processing device in which, when processing for moving displayed content is being performed in response to movement of an indicator, such as a finger, on an input pad and the indicator is subsequently continuously moved along a curved path, the processing for moving the displayed content can be continuously performed with a simple operation so that a display screen can be moved in a continuous manner.

Various examples provide an input processing device that includes an input member having an input pad and a detector that detects a position of the input pad with which an indicator comes into contact, and a controller that changes displayed content displayed on a display device on the basis of an input signal obtained from the input member. The controller performs a first process of determining whether or not a contact position with which the indicator is in contact is in a preliminarily set function region in the input pad on the basis of the input signal, a second process of executing display movement processing for moving the displayed content when the contact position of the indicator is detected to be moving in an enabling direction for enabling processing within the function region, and a third process of causing the display movement processing to be continuously performed when the controller determines that the contact position of the indicator is moved by a certain distance or more in the enabling direction within the function region and is subsequently moved continuously to a curved path continuing in one direction.

In an input processing device according to the examples disclosed herein, the display movement processing is continuously performed when the contact position of the indicator, such as a finger, is moved by a predetermined distance in one direction within the preliminarily set function region in the input pad and is subsequently moved along a curved path. Thus, the displayed content can be continuously moved without having to move the indicator away from the input pad over and over again. By stopping the indicator or moving the indicator away from the input pad, the displayed content can be stopped from moving, thereby allowing for display changing processing with sensory correspondence between the movement of the indicator and the movement of the display screen.

Based on a change in capacitance occurring when a low-potential indicator, such as a finger, comes close to or into contact with the input pad described in this specification, the input pad can output the position facing the indicator as coordinate data. Also, a resistor film or the like may be provided between insulators that face each other. In that example, the input pad can detect a change in resistance occurring when the insulators are partially brought into contact with each other by a finger so as to obtain the position in contact with the indicator as coordinate data.

Furthermore, the input pad and the display device may be disposed at separate locations such that the displayed content on the display device can be changed by operating the input pad, or the input pad may be of a transparent type that is provided over the display device.

For example, the function region may be a vertically long region extending vertically in the input pad. In that example, the second process preferably includes performing the display movement processing for moving the displayed content in one of an upward direction and a downward direction when the contact position of the indicator is moved in the downward direction, which is the enabling direction, within the vertically long region, and performing the display movement processing for moving the displayed content in the other one of the upward direction and the downward direction when the contact position of the indicator is moved in the upward direction, which is the enabling direction.

In this example, a continuing process of the third process includes causing the displayed content to be moved continuously in the one direction when the contact position of the indicator is moved by a certain distance or more in the downward direction and is subsequently moved to a clockwise curved path within the vertically long region, and causing the displayed content to be moved continuously in the other direction when the contact position of the indicator is moved by a certain distance or more in the upward direction and is subsequently moved to a counterclockwise curved path.

Furthermore, the function region may be a horizontally long region extending horizontally in the input pad. In that example, the second process includes performing the display movement processing for moving the displayed content in one of a rightward direction and a leftward direction when the contact position of the indicator is moved in the rightward direction, which is the enabling direction, within the horizontally long region, and performing the display movement processing for moving the displayed content in the other one of the rightward direction and the leftward direction when the contact position of the indicator is moved in the leftward direction, which is the enabling direction.

In this example, a continuing process of the third process includes causing the displayed content to be moved continuously in the one direction when the contact position of the indicator is moved by a certain distance or more in the rightward direction and is subsequently moved to a counterclockwise curved path within the horizontally long region, and causing the displayed content to be moved continuously in the other direction when the contact position of the indicator is moved by a certain distance or more in the leftward direction and is subsequently moved to a clockwise curved path.

Furthermore, a continuing process of the third process may include inverting the moving direction of the displayed content when the contact position of the indicator is changed continuously from a clockwise direction to a counterclockwise direction or from the counterclockwise direction to the clockwise direction.

Accordingly, the displayed content can be moved bidirectionally by moving the indicator in a circle along the curved path in the reverse direction, thereby facilitating accessibility to a target position of the displayed content.

### BRIEF DESCRIPTION OF THE DRAWINGS

FIG. 1 is a perspective view of a personal computer equipped with an input processing device according to the disclosure;

FIG. 2 is a plan view of a flat input member;

FIG. 3 is a circuit block diagram of the input processing device;

FIG. 4 illustrates a flow chart showing processing according to the disclosure;

FIG. 5 illustrates a flow chart showing processing in a process flow I;

FIG. 6 illustrates a flow chart showing processing in the process flow I;

FIG. 7 illustrates a flow chart showing processing in the process flow I;

FIGS. 8A and 8B illustrate a flow chart of a process flow continuing from the process flow in FIG. 7;

FIG. 9 illustrates a flow chart showing processing in a process flow II;

FIG. 10 illustrates a flow chart showing processing in a process flow IV; and

FIGS. 11A and 11B illustrate a flow chart showing processing in a process flow V.

### DESCRIPTION OF THE EXEMPLARY EMBODIMENTS

The following description is intended to convey a thorough understanding of the embodiments described by providing a number of specific embodiments and details involving input processing devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

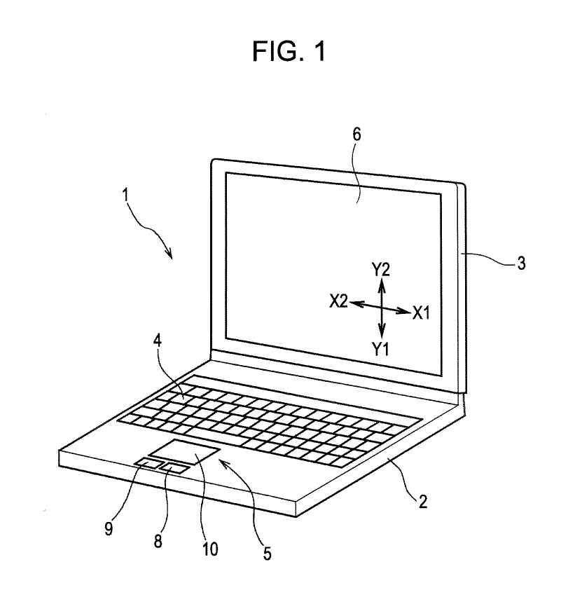

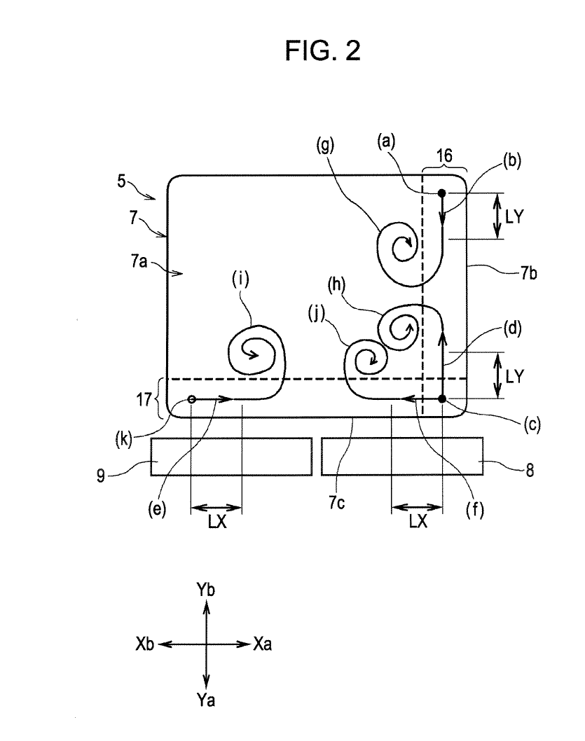

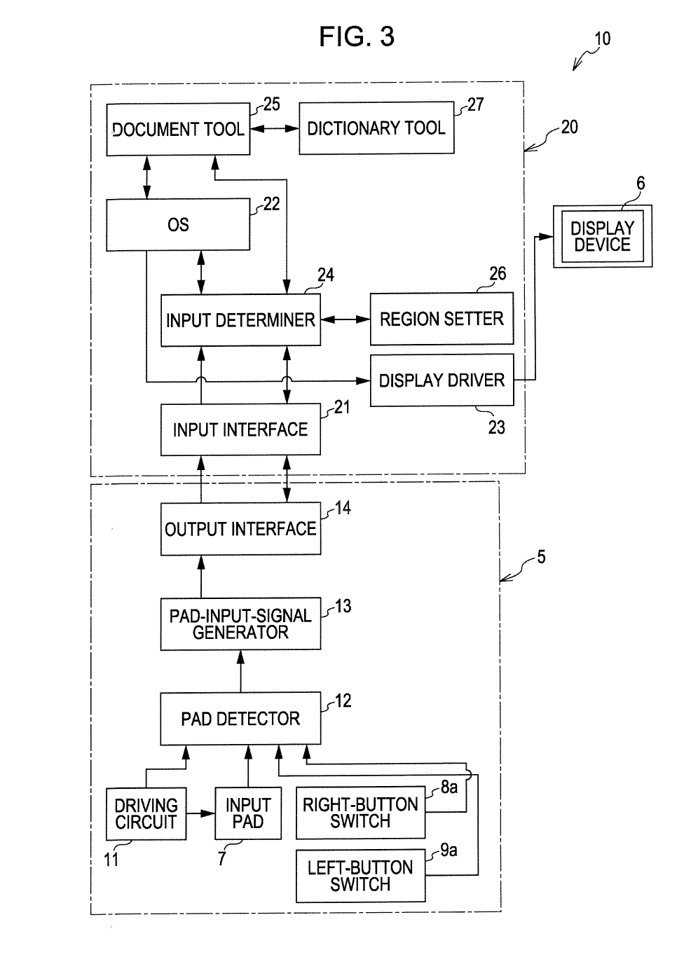

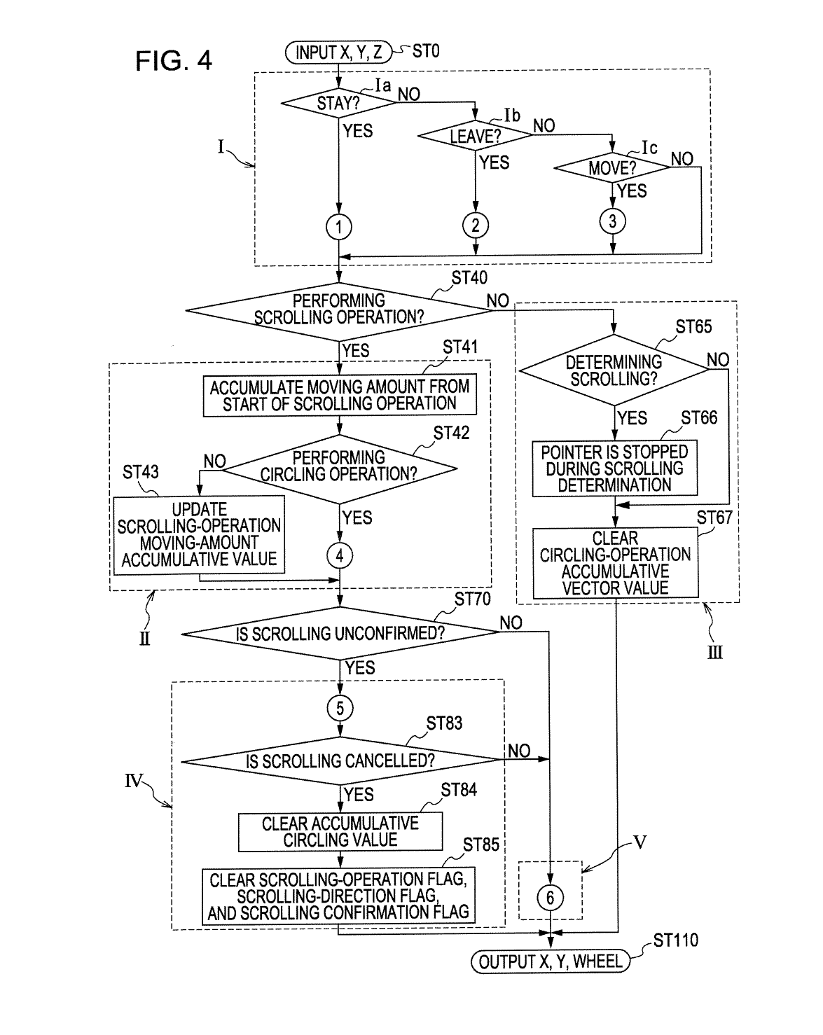

FIG. 1 is a perspective view showing a notebook-type personal computer equipped with an input processing device according to the present invention. FIG. 2 is a plan view of a flat input member. FIG. 3 is a circuit block diagram of the input processing device. FIGS. 4 to 10 are flow charts showing processing performed by the input processing device.

A personal computer 1 shown in FIG. 1 may have a main body section 2 and a cover section 3 that may be connected to each other in foldable manner. A control panel on a surface of the main body section 2 may be provided with a keyboard device 4 and a flat input member 5. A front surface of the cover section 3 may be provided with a display device 6 that may be formed of a liquid-crystal display panel.

As shown in FIG. 2 in an enlarged view, the flat input member 5 may include an input pad 7, a right button 8 located at a lower-right position thereof, and a left button 9 located at a lower-left position thereof.

The input pad 7 may have a flat input surface 7a. In the input pad 7, a plurality of X-electrodes extending in an X-axis direction and a plurality of Y-electrodes extending in a Y-axis direction may be disposed facing each other with an insulating layer therebetween, and a detector electrode may be provided between each neighboring pair of X-electrodes. These electrodes may be covered with a thin insulating film, and the surface of the insulating film may serve as the input surface 7a. Since capacitance is formed between a finger and each electrode when the finger, which is an electrically conductive indicator substantially with a ground potential, touches the input surface 7a, the capacitance between the detector electrode and the X-electrode and the capacitance between the detector electrode and the Y-electrode may change at the section substantially in contact with the finger.

As shown in FIG. 3, a driving circuit 11 provided in the input member 5 may sequentially apply pulse-like voltage to the X-electrode and also sequentially apply pulse-like voltage to the Y-electrode at a timing different from that for the X-electrode. When the pulse-like voltage is being applied to the X-electrode or the Y-electrode and the indicator approaches that electrode, a change in the capacitance may cause the voltage between the X-electrode and the detector electrode or the voltage between the Y-electrode and the detector electrode to change. This change in the voltage may be detected by a pad detector 12 via the detector electrode. In addition to detecting the change in the voltage via the detector electrode, the pad detector 12 may obtain timing information regarding which one of the X-electrodes or the Y-electrodes the voltage is applied to at that time, thereby detecting a finger contact position on an X-Y coordinate system on the input surface 7a.

Accordingly, when the finger in contact with the input surface 7a is moved, the path of the finger can be detected on the X-Y coordinate system. When a so-called tapping operation of quickly bringing a finger towards the input surface 7a and then quickly moving the finger away therefrom is performed, since the capacitance between the electrodes changes within a short period of time, this change in the capacitance can be detected by the pad detector 12.

In the input member 5, the pad detector 12 may generate an operation signal including X-Y coordinate information indicating the finger contact position on the input surface 7a and send the signal to a pad-input-signal generator 13. Furthermore, an operation signal of a right-button switch 8a operated by pressing the right button 8 and an operation signal (click signal) of a left-button switch 9a operated by pressing the left button 9 also may be detected by the pad detector 12, and operation information thereof are sent to the pad-input-signal generator 13.

In the pad-input-signal generator 13, the X-Y coordinate information included in the operation signal of the input pad 7 detected by the pad detector 12, the operation signal of the right-button switch 8a, and the operation signal of the left-button switch 9a may be made into format data (input signal) with a predetermined number of bytes and are output from an output interface 14. An input signal output from the output interface 14 may be sent to an input interface 21 provided in a controller 20 of the personal computer 1. The output interface 14 and the input interface 21 may be connected to each other with, for example, a USB interface.

The controller 20 of the personal computer 1 may store various software programs. The controller 20 also may store an operating system (OS) 22. The operating system 22 may control a display driver 23 so as to display various kinds of information on the display device 6.

A document tool 25 may be installed as a software program in the controller 20. The document tool 25 may exhibit a function of a word processor and may be accompanied by a dictionary tool 27. When a word-processor function screen is displayed on the display device 6, characters and functions can be input by operating the keyboard so that the input character strings are displayed on the screen of the display device 6.

An input determiner 24 may be installed as a software program in the controller 20. The format data (input signal) obtained from the pad-input-signal generator 13 may be sent to the input determiner 24 via the input interface 21. The input determiner 24 may be accompanied by a region setter 26 that may divide the area of the input surface 7a of the input pad 7 into regions and may store the divided regions. This region setter 26 also may be installed as a software program together with the input determiner 24.

The allocation and the dimensions of the regions on the input surface 7a set in the region setter 26 as well as the distribution of the functions for the individual regions can be changed by setting the controller 20 in a setting menu mode and operating the input pad 7, the right-button switch 8a, and the left-button switch 9a.

As shown in FIG. 2, in this embodiment, a first function region 16 and a second function region 17 may be set in the input surface 7a by the region setter 26. The first function region 16 may be a vertically long region having a fixed width and extending in a Ya-Yb direction along an Xa-side edge 7b of the input surface 7a. The second function region 17 may be a horizontally long region having a fixed width and extending in an Xa-Xb direction along a Ya-side edge 7c of the input surface 7a. The width of the first function region 16 and the width of the second function region 17 can be changed by switching the controller 20 to the setting menu mode and operating the input pad 7 and the like. Moreover, the first function region 16 can be moved to an Xb-side edge, or the second function region 17 can be moved to a Yb-side edge.

The input determiner 24 may determine which region of the input surface 7a of the input pad 7 the finger is in contact with on the basis of the X-Y coordinate information included in the input signal received from the pad-input-signal generator 13. If it is determined that the finger contact position is located at neither of the first function region 16 nor the second function region 17, coordinate data equivalent to that when the input signal is generated by using a mouse, which is an external device, may be generated on the basis of the X-Y coordinate information included in the input signal, and the operating system 22 may be notified of the coordinate data. In this case, a cursor displayed on the display screen of the display device 6 may move in an X1-X2 direction and a Y1-Y2 direction in accordance with the moving direction of the finger in contact with the input surface 7a. By performing this operation to select a function key or a menu displayed on the screen and then to perform a tapping operation or operate the right button 8, the selected function key or menu can be executed.

When the input determiner 24 determines that a finger is in contact with the first function region 16 or the second function region 17 in the input surface 7a of the input pad 7, the operation may proceed to display movement processing, depending on subsequent movement of the indicator contact position.

In display movement processing, when it is detected that the indicator contact position is moving vertically within the first function region 16, the input determiner 24 may send, to the operating system 22, a scrolling operation signal equivalent to that when a scroll bar on the right side of the screen is operated vertically by using the mouse.

For example, as shown in FIG. 2, when the finger contact position is moved in the Ya direction along a linear path (b) from a position (a) at the Yb side of the first function region 16 in the input surface 7a, a scrolling operation of moving an image or a character string input by using the word processor, which is displayed content displayed on the display screen, upward (i.e., in the Y2 direction) may be executed. On the other hand, when the finger contact position is moved in the Yb direction along a linear path (d) from a position (c) at the Ya side of the first function region 16, a scrolling operation of moving an image or a character string downward (i.e., in the Y1 direction) may be executed.

Next, when the indicator contact position is moved sideways within the second function region 17, the input determiner 24 may send, to the operating system (OS) 22, an operation signal equivalent to that when a scroll bar on the lower side of the screen is operated by using the mouse.

For example, as shown in FIG. 2, when the finger contact position is moved in the Xa direction along a linear path (e) from a position (k) at the Xb side of the second function region 17 in the input surface 7a, a scrolling operation of moving an image or a character string, which is displayed content displayed on the display screen, in the left direction (X2 direction) may be executed. On the other hand, when the finger contact position is moved in the Xb direction along a linear path (f) from the position (c) at the Xa side of the second function region 17, a scrolling operation of moving an image or a character string in the right direction (X1 direction) may be executed.

Next, after commencing a scrolling operation in the Y2 direction for the image or the character string by moving the finger, which is in contact with the position (a) at the Yb side of the first function region 16, in the Ya direction, the finger is moved by a predetermined distance Ly or more without being moved outside the first function region 16. Then, without being moved away from the input surface 7a and also without stopping, the finger is continuously moved in a circle along a clockwise curved path (g), causing the scrolling operation set in the linear path (b) to continue. Specifically, the input determiner 24 continuously may send, to the operating system (OS) 22, an operation signal equivalent to that when the scroll bar on the right side of the screen is operated by using the mouse.

A determination process for determining whether or not the finger contact position on the input surface 7a is moved to the curved path (g) may be performed by monitoring whether or not the finger contact position continues to change with a predetermined curvature or more after a vector of the linear path (b) circles continuously in the clockwise direction by a predetermined angle or more (e.g., 90° or more, or 180° or more). Therefore, although the finger may be normally moved in a circle such that the diameter of the curved path (g) is constantly unchanging, the scrolling operation on the screen may continue even when the curvature of the curved path (g) changes at a midpoint, so long as the finger contact position changes by a preliminarily set curvature or more.

The curved path (g) may be limited to finger movement only in a region not belonging to the first function region 16 or the second function region 17, or may be set so that the scrolling operation continues so long as the finger is moving along the curved path (g) in any location on the input surface 7a. When the first function region 16 is given a wide area, the scrolling operation may be set to continue only when the finger is moving along the curved path (g) within the first function region 16.

When the finger sliding along the curved path (g) on the input surface 7a stops, the scrolling operation on the screen may stop. Even when the finger is subsequently slid along the curved path (g) again without being moved away from the input surface 7a, the scrolling operation for the displayed content may not resume. Also, if the finger stoppage is within a predetermined time period, the scrolling operation may resume in response to subsequent finger movement along the curved path (g) so long as the finger is not moved away from the input surface 7a.

When the finger in the course of moving along the curved path (g) moves away from the input surface 7a, the scrolling operation may end. Moreover, when a change in the path of the finger moving in a circle on the input surface 7a falls below the predetermined curvature, the scrolling operation may end.

Similarly, after moving the finger contact position in the Yb direction along the linear path (d) by the predetermined distance Ly or more from the position (c) at the Ya side of the first function region 16 without moving the finger outside the first function region 16, if the finger is moved continuously along a counterclockwise curved path (h) without being moved away from the input surface 7a, the scrolling operation of moving the displayed content on the screen downward (i.e., Y1 direction) may be continuously performed. In this case, if the path of the finger contact position continues to change by a predetermined curvature or more after a Yb-direction vector of the linear path (d) circles continuously in the counterclockwise direction by a predetermined angle or more (e.g., 90° or more, or 180° or more), the scrolling operation may continue.

Next, when the finger circling movement is switched to the counterclockwise direction without the finger being moved away from the input surface 7a while the displayed content is being scrolled in the Y2 direction by moving the finger, which is in contact with the input surface 7a, in a circle along the curved path (g), the scrolling direction for the displayed content may switch to the Y1 direction. Subsequently, the scrolling operation in the Y1 direction continues so long as the finger in contact with the input surface 7a may continue to move in a circle in the counterclockwise direction. In this case, when a vector of the curved path (g) changes by a predetermined angle (e.g., 90°) or more in the counterclockwise direction and subsequently satisfies the same condition as that for the curved path (h), it may be determined that the finger contact position is inverted in the counterclockwise direction.

When the finger moves in a circle in the counterclockwise direction without stopping from the clockwise curved path (g) or without stopping for a predetermined time period or more, it may be determined that the path of the contact position is inverted in the counterclockwise direction, and the scrolling operation may be continued in an inverted manner. However, when the finger is stopped for a predetermined time period or more, the scrolling operation may not be performed even if the circling direction of the finger is subsequently inverted.

Similarly, when the displayed content is scrolled in the Y1 direction by moving the finger contact position from the linear path (d) to the counterclockwise curved path (h), the scrolling direction for the displayed content can be switched to the Y2 direction by switching the curved path of the finger contact position to the clockwise direction.

Next, when the finger contact position is moved along the linear path (e) from the position (k) at the Xb side of the second function region 17 by a predetermined distance Lx or more and is then continuously moved to a counterclockwise curved path (i), the scrolling operation of moving the displayed content in the X2 direction may continue while the finger is moving in a circle along the curved path (i). On the other hand, when the finger contact position is moved in the Xb direction along the linear path (f) by the predetermined distance Lx or more from the position (c) at the Xa side of the second function region 17 and is then continuously moved to a clockwise curved path (j), the scrolling operation of moving the displayed content in the X1 direction may continue while the finger is moving in a circle along the curved path (j).

Furthermore, when the finger is moved in a reversed circle by inverting the circling direction of the finger to the clockwise direction at a midpoint of the curved path (i), the scrolling direction for the displayed content may be inverted from the X2 direction to the X1 direction. Similarly, when the finger is moved in a reversed circle by inverting the circling direction of the finger to the counterclockwise direction at a midpoint of the curved path (j), the scrolling direction for the displayed content may be switched from the X1 direction to the X2 direction. The conditions in this case are the same as those for when switching from the curved path (g) to the counterclockwise direction as well as for when switching from the curved path (h) to the clockwise direction.

The determination process of the input determiner 24 will now be described in detail with reference to flow charts shown in FIGS. 4 to 10.

In the flow charts shown in FIGS. 4 to 10, steps 0, 1, 2, 3, and onward are expressed as “ST0, ST1, ST2, ST3, and onward”, respectively.

As shown in FIG. 4, in step ST0, when information indicating that a finger is in contact with the input surface 7a is sent to the input determiner 24 from the pad-input-signal generator 13, it may be determined in a process flow I whether or not a scrolling operation in the first function region 16 is performed or a scrolling operation in the second function region 17 is performed.

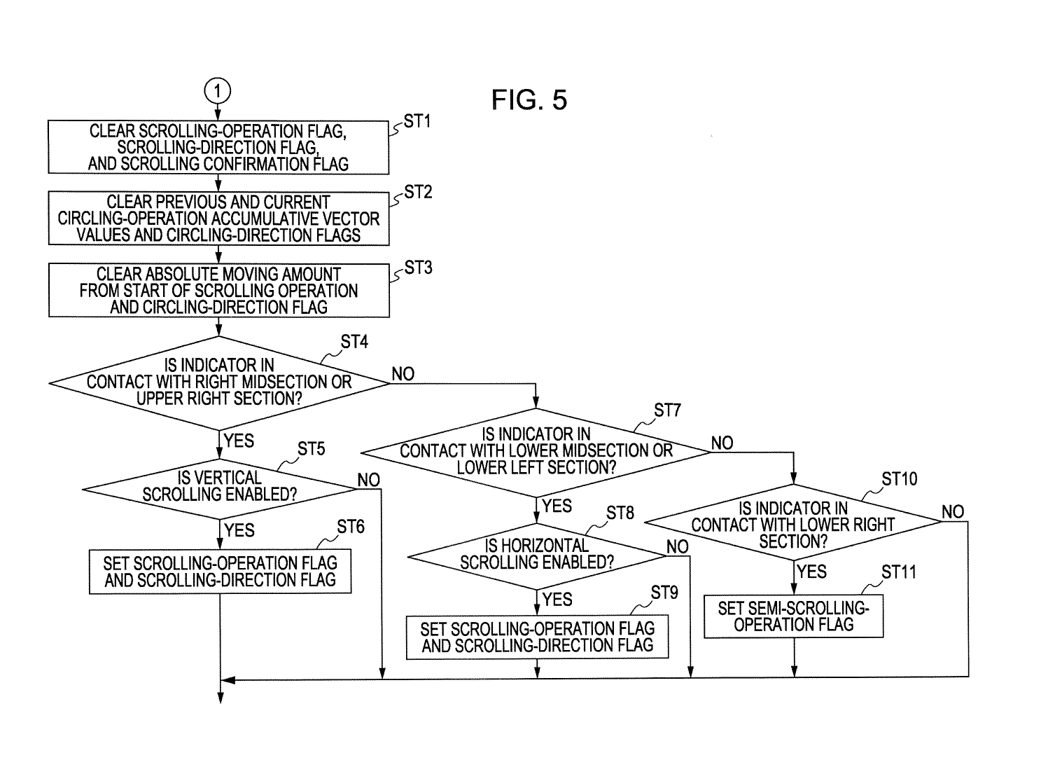

If a finger contact position on the input pad 7 is in a stopped state in step 1a of the process flow I, the process may proceed to a process shown in FIG. 5.

In steps ST1 to ST3 shown in FIG. 5, a scrolling-operation flag and a scrolling-direction flag, which may be historical information, may be cleared, and an accumulative movement value, for example, may be cleared, thereby setting an initial state. If it is determined in step ST4 that the finger contact position is located at the position (a) at the Yb side of the first function region 16 or at a midpoint in the Ya-Yb direction of the first function region 16, the process may proceed to step ST5. In step ST5, if a flag that allows vertical scrolling is set, the process proceeds to step ST6 where a scrolling-direction flag, which indicates that vertical scrolling in the downward direction (Ya direction) is possible, may be set.

In step ST7 shown in FIG. 5, if it is determined that the finger contact position is located at the position (k) at the Xb side of the second function region 17 or at a midpoint in the Xa-Xb direction of the second function region 17, the process may proceed to step ST8. In step ST8, if a flag that enables horizontal scrolling is set, the process proceeds to step ST9 where a scrolling-direction flag, which indicates that horizontal scrolling in the right direction (Xa direction) is possible, may be set.

In step ST10, if it is determined that the finger contact position is located at the position (c) shown in FIG. 2, since it is unclear as to whether to subsequently perform vertical scrolling or horizontal scrolling, the process may proceed to step ST11 where a semi-scrolling-operation flag may be set.

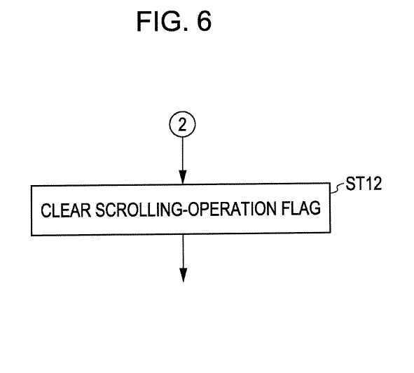

In step Ib in the process flow I shown in FIG. 4, if the finger is moved away from the input surface 7a, the process may proceed to step ST12 shown in FIG. 6 where a scrolling-operation flag may be cleared.

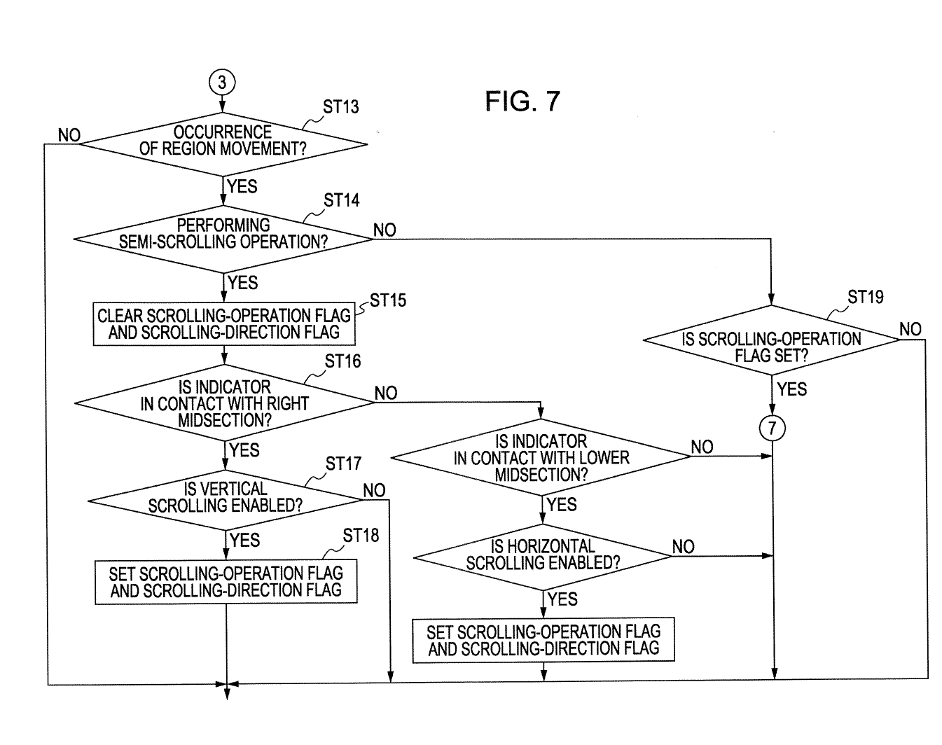

In step Ic in the process flow I, if it is detected that the finger is in contact with the input surface 7a and is moving thereon, the process may proceed to a flow shown in FIG. 7.

In the flow shown in FIG. 7, it is determined in step ST13 whether the finger contact position is located in the first function region 16, the second function region 17, or a region other than these regions 16 and 17. If the finger contact position is located within the first function region 16 or the second function region 17, the process may proceed to step ST14 where it may be determined whether a semi-scrolling-operation flag is set.

When the semi-scrolling-operation flag is set in step ST14, the process may proceed to step ST15 where a scrolling-operation flag and a scrolling-direction flag may be cleared. If it is determined in step ST16 that the finger contact position has moved to a midpoint in the Ya-Yb direction of the first function region 16 and when vertical scrolling is enabled in step ST17, the process may proceed to step ST18 where a scrolling-operation flag and a scrolling-direction flag that enable vertical scrolling in the Yb direction may be set.

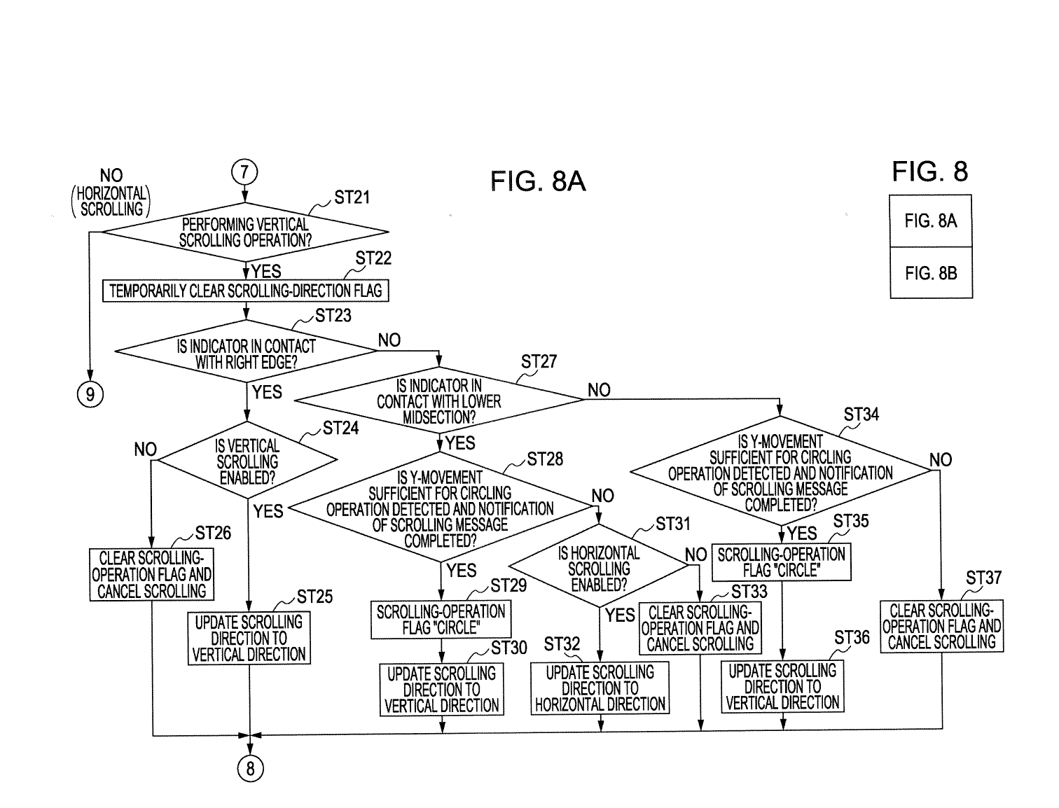

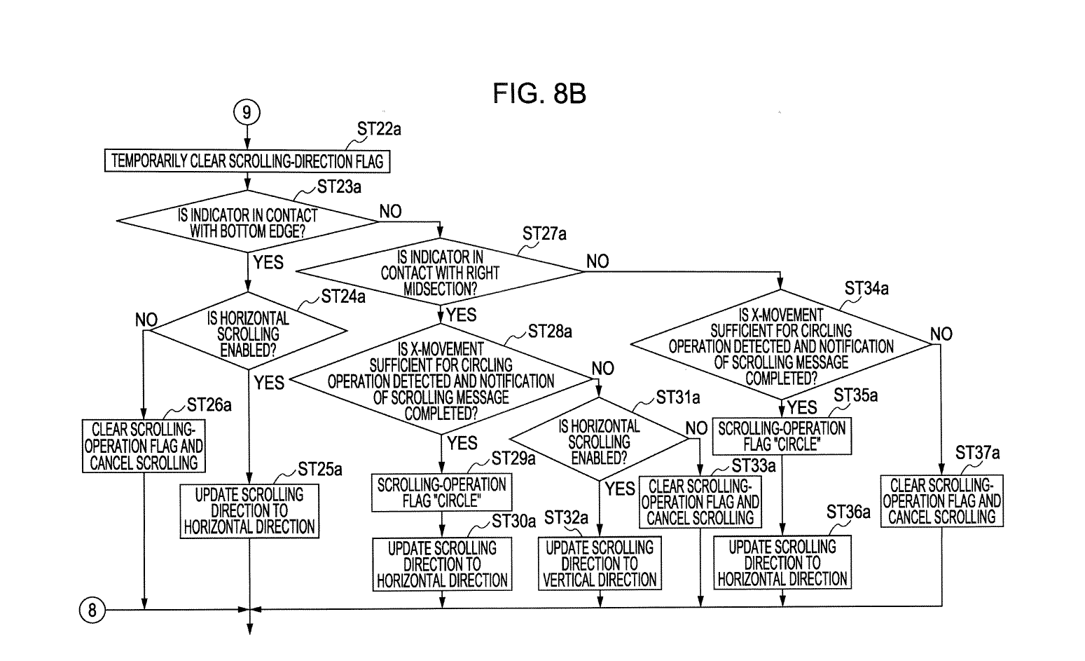

When a semi-scrolling-operation flag is not set in step ST14 in FIG. 7, the process may proceed to step ST19. In step ST19, it may be determined whether or not a scrolling-operation flag is already set. If a scrolling-operation flag is set, the process may proceed to a process shown in FIGS. 8A and 8B.

When it is determined in step ST21 in FIG. 8A that vertical scrolling is currently being performed, the process may proceed to step ST22 where a scrolling-direction flag is cleared once, and then may proceed to step ST23. If it is determined in step ST23 that the finger contact position is located within the first function region 16, the process may proceed to step ST24 where it may be determined whether or not a vertical scrolling operation for the displayed content may be enabled. When enabled, the process may proceed to step ST25 where the vertical scrolling may be continuously performed. If vertical scrolling is not enabled in step ST24, the process may proceed to step ST26 where the scrolling-operation flag may be cleared so as to end the vertical scrolling.

In step ST27 in FIG. 8A, when the finger contact position is moved to the second function region 17 during the vertical scrolling, the process may proceed to step ST28. Step ST28 is a step for detecting whether a Y-direction moving amount prior to moving to a curved path exceeds the predetermined distance Ly and for detecting finger movement (such as a movement vector or the curvature of a path) that allows for determination that the vertical scrolling operation is switched to a curved-path operation, and also for confirming whether the operating system (OS) 22 may be notified of the scrolling state. When a moving amount by which it can be determined that the operation is switched to a curved-path operation is detected in step ST28, a flag that indicates a curved-path operation may be set in step ST29, and the vertical scrolling may be continuously performed in step ST30. Specifically, when the finger is moved to the second function region 17 during vertical scrolling performed by operating the first function region 16, if it is determined that the finger is moved to a curved path, the vertical scrolling may be continuously performing without switching to horizontal scrolling.

If it is not confirmed in step ST28 that the finger contact position is located in a curved path, the process proceeds to step ST31 where it may be determined whether or not horizontal scrolling is possible. At this point, since the input determiner 24 detects an already ongoing scrolling state, if it is determined in step ST31 that horizontal scrolling is possible, the process may proceed to step ST32 where the scrolling direction may be changed from the vertical direction to the horizontal direction. If horizontal scrolling is not enabled in step ST31, the scrolling-operation flag may be cleared in step ST33 so as to end the scrolling itself.

During the vertical scrolling in step ST21, if it is determined that the finger contact position is not located in the first function region 16 in step ST23 and that the contact position is not located in the second function region 17 in step ST27, the process may proceed to step ST34. Step ST34 is a step for detecting finger movement (such as a movement vector or the curvature of a path) that may allow for determination that the operation may be switched to a curved path (g) operation after there is a linear movement by the predetermined distance Ly or more in the first function region 16 and for confirming whether the operating system (OS) 22 may be notified of the scrolling state. When it is determined that the finger contact position is moved to the curved path in step ST34, a flag that indicates a curved-path operation is set in step ST35, and the vertical scrolling may be continuously performed in step ST36 so long as the curved path (g) continues to extend. If it is not confirmed in step ST34 that the finger contact position is located in a curved path, the process may proceed to step ST37 where the scrolling ends.

When a scrolling-operation flag is set (step ST19) and a vertical scrolling operation is not being performed in step ST21 in FIG. 8A, it may be determined that horizontal scrolling is being performed. The process then may proceed to step ST22a where a scrolling-direction flag may be cleared once. Steps 22a to 37a shown in FIG. 8B may be equivalent to a process in which the first function region 16 and the second function region 17 may be inverted in steps 22 to 37.

In steps 22a to 37a, when finger movement that allows for determination that the operation is switched to a curved-path operation can be detected and the operating system 22 is notified of the scrolling state as the finger contact position is moved from the second function region 17 to the first function region 16 during horizontal scrolling, it may be determined that the finger contact position is located in a curved path, and the horizontal scrolling may be continuously performed. Similarly, when it is determined that the finger contact position is located in a curved path in a region not belonging to the first function region 16 or the second function region 17, like (i) in FIG. 2, the horizontal scrolling may be continuously performed.

When it is confirmed in step ST40 in FIG. 4 that scrolling is being performed, a calculation of accumulating a scrolling amount corresponding to a moving amount of the finger contact position is performed in a process flow II, or a process for converting the moving amount to a scrolling amount may be performed when the finger contact position is being moved along the curved path.

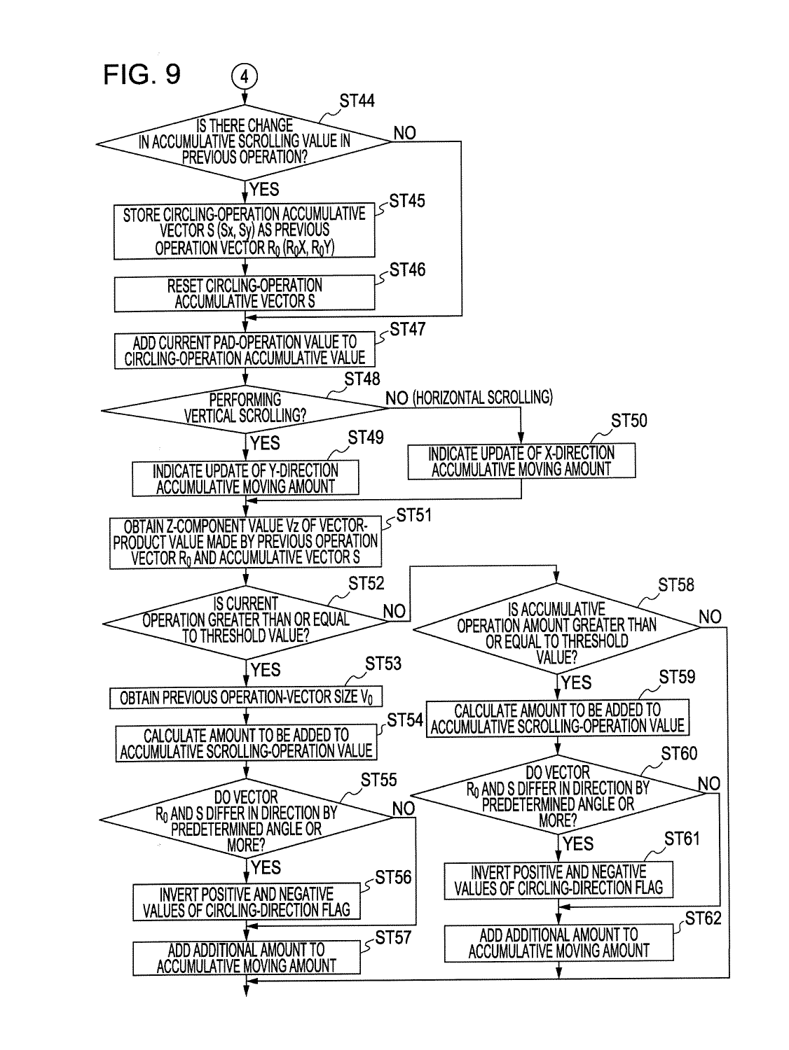

In the process flow II, the moving amount of the finger contact position from the start of a scrolling operation may be accumulated in step ST41. In step ST42, if it is determined that the finger contact position is not moved along a curved path, the process may proceed to step ST43 where the scrolling may be continuously performed by using an integrated value of the moving amount of the linearly moving finger. If it is determined that the finger contact position is moved along a curved path in step ST42, the process may proceed to a process shown in FIG. 9.

When the accumulative value of the scrolling amount converted from the curved path changes in step ST44 in FIG. 9, the process may proceed to step ST45 where an operation vector of the curved path may be updated to a latest operation vector R0, and the accumulative value of the past operation vector of the curved path may be reset in step ST46.

In step ST47, the currently-obtained moving amount of the finger contact position is added to the operation amount of the curved path. In step ST48, if vertical scrolling for moving the currently displayed content in the Y-axis direction is performed, the process may proceed to step ST49 where the vertical scrolling may be continuously performed. If horizontal scrolling for moving the currently displayed content in the X-axis direction is performed in step ST48, the process may proceed to step ST50 where the horizontal scrolling may be continuously performed.

In step ST51, a vector-product value, that is, a change in the vector of a finger movement path, such as the curvature, is obtained from an accumulative value S of the currently detected operation vector and the updated and maintained operation vector R0. If it is determined in step ST52 that the vector-product value, such as the curvature, is greater than or equal to a threshold value, the process may proceed to step ST53 where the vector size may be obtained. In step ST54, the vector size may be converted to an accumulative value for vertical scrolling.

In steps ST54 and ST55, if it is determined that the updated and maintained operation vector R0 and the currently detected operation vector differ from each other by a predetermined angle or more, the process may proceed to step ST56 where the direction of a curved-path operation flag may be inverted, and the process may proceed to step ST57. When it is not determined that the vector is inverted in step ST55, the process still may proceed to step ST57 where a moving amount for vertical scrolling may be added.

If it is not determined in step ST52 that the vector-product value, such as the curvature, is greater than or equal to the threshold value, the process may proceed to step ST58 where it may be determined whether or not the moving amount along the path of the finger is greater than or equal to a threshold value. If the moving amount is determined to be greater than or equal to the threshold value, the process may proceed to steps ST59 to ST62. Steps STS9 to ST62 may be the same as steps STS4 to ST57.

Specifically, although the scrolling is continuously performed in steps ST52 to ST57 if the curvature of the finger contact position is equal to or greater than a predetermined curvature, the scrolling may be continuously performed in steps ST58 to ST62 when it may be determined that the finger contact position is moving along a curved path on the basis of the previous path even if the curvature of the finger contact position may not exceed the threshold value.

When a scrolling operation is not being performed in step ST40 in FIG. 4, the process may proceed to a process flow III. If a scrolling mode cannot be detected or if the finger contact position is stopped during scrolling in steps ST65, ST66, and ST67 in the process flow III, the accumulative value of the scrolling may be cleared. When there is subsequent finger movement, a new accumulative movement value may be added again.

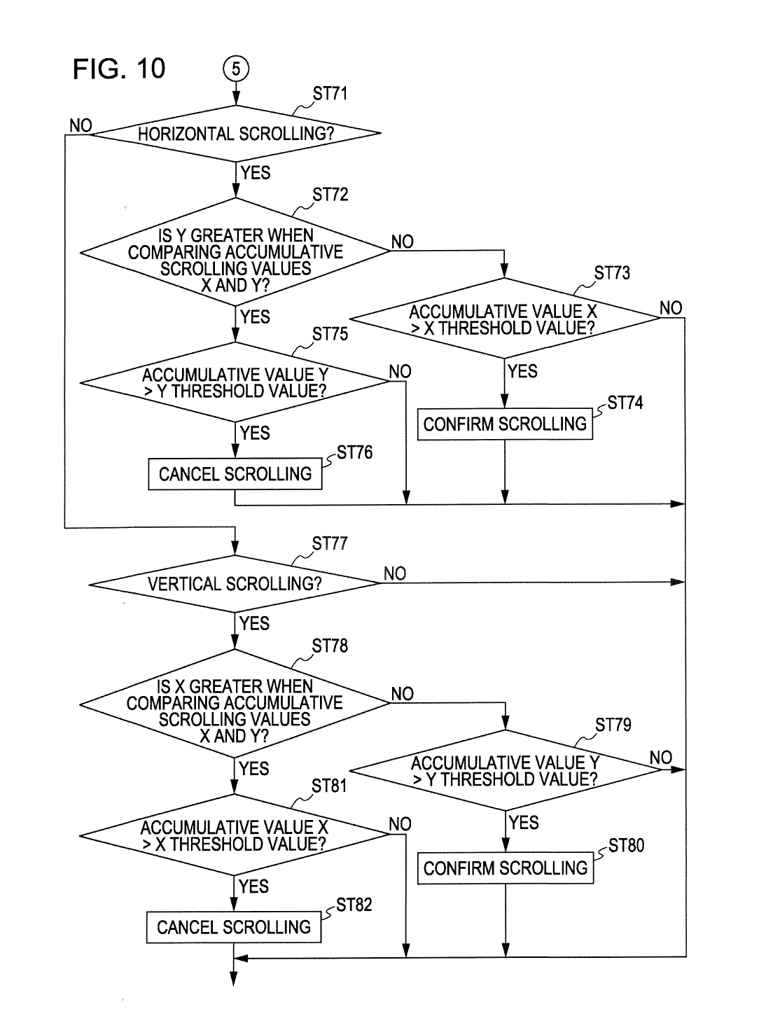

When it is not confirmed in step ST70 shown in FIG. 4 whether or not a scrolling operation is performed, the process may proceed to a process flow IV. In the process flow IV, a process shown in FIG. 10 may be performed.

In step ST71 in FIG. 10, it may be determined whether or not the finger contact position is located in the second function region 17. When it is determined in step ST71 that the finger contact position is located in the second function region 17, the process may proceed to step ST72 where an accumulative value of the moving amount of the finger contact position in the vertical direction (Y-axis direction) and an accumulative value of the moving amount in the horizontal direction (X-axis direction) may be compared in terms of magnitude. If the accumulative movement value for the horizontal direction (X-axis direction) is greater than the accumulative movement value for the vertical direction (Y-axis direction), the process may proceed to step ST73 where it may be determined whether or not the accumulative movement value for the horizontal direction is greater than a threshold value. If the accumulative movement value for the horizontal direction is greater than the threshold value, the process may proceed to step ST74 where horizontal scrolling may be confirmed. If the accumulative movement value for the vertical direction is greater than that for the horizontal direction in step ST72 and the accumulative movement value for the vertical direction is greater than a threshold value in step ST75, the process may proceed to step ST76 where scrolling may be cancelled.

When it is determined in step ST77 that the finger contact position is located in the first function region 16, the process may proceed to step ST78 where an accumulative value of the moving amount of the finger contact position in the vertical direction (Y-axis direction) and an accumulative value of the moving amount in the horizontal direction (X-axis direction) may be compared in terms of magnitude. If the accumulative movement value for the vertical direction (Y-axis direction) is greater and the accumulative movement value for the vertical direction (Y-axis direction) is greater than the threshold value in step ST79, the process may proceed to step ST80 where vertical scrolling may be confirmed. If the accumulative movement value for the horizontal direction is greater than the threshold value in step ST81, the process may proceed to step ST82 where scrolling may be cancelled.

In the process flow IV shown in FIG. 4, when scrolling is cancelled in step ST83, the process may proceed to steps ST84 and ST85 where all of the flags and accumulative values may be cleared.

When vertical scrolling and horizontal scrolling are confirmed in step ST70 in FIG. 4, the process may proceed to a process flow V.

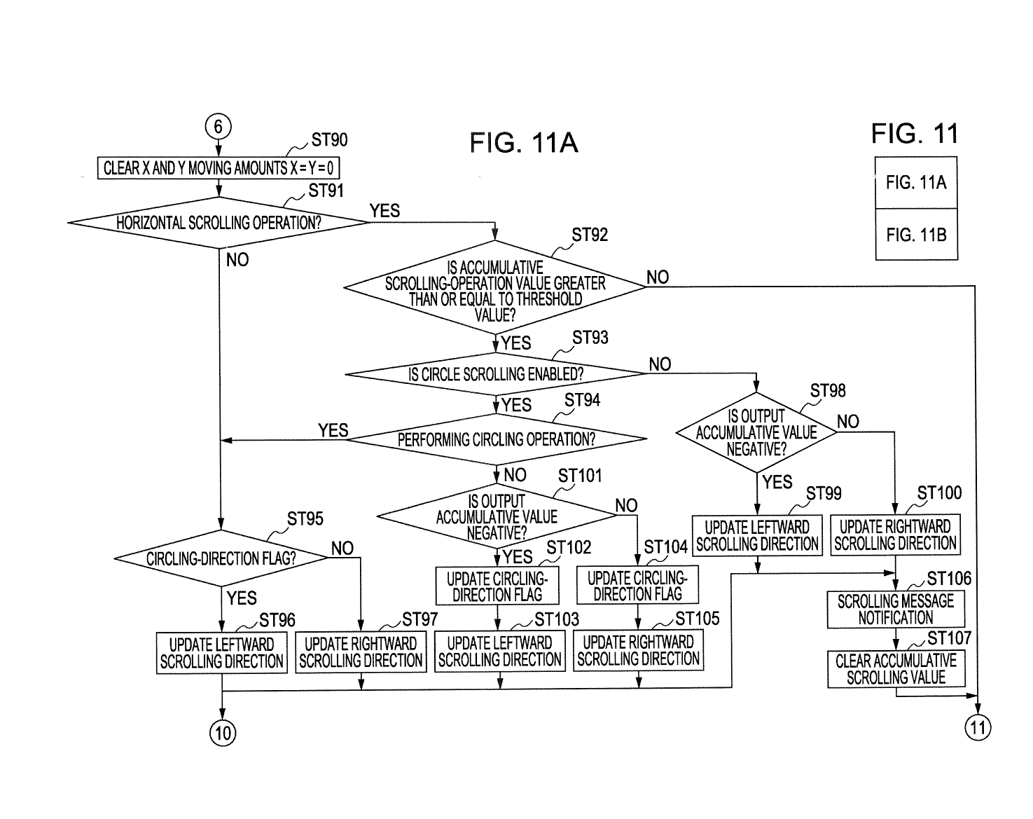

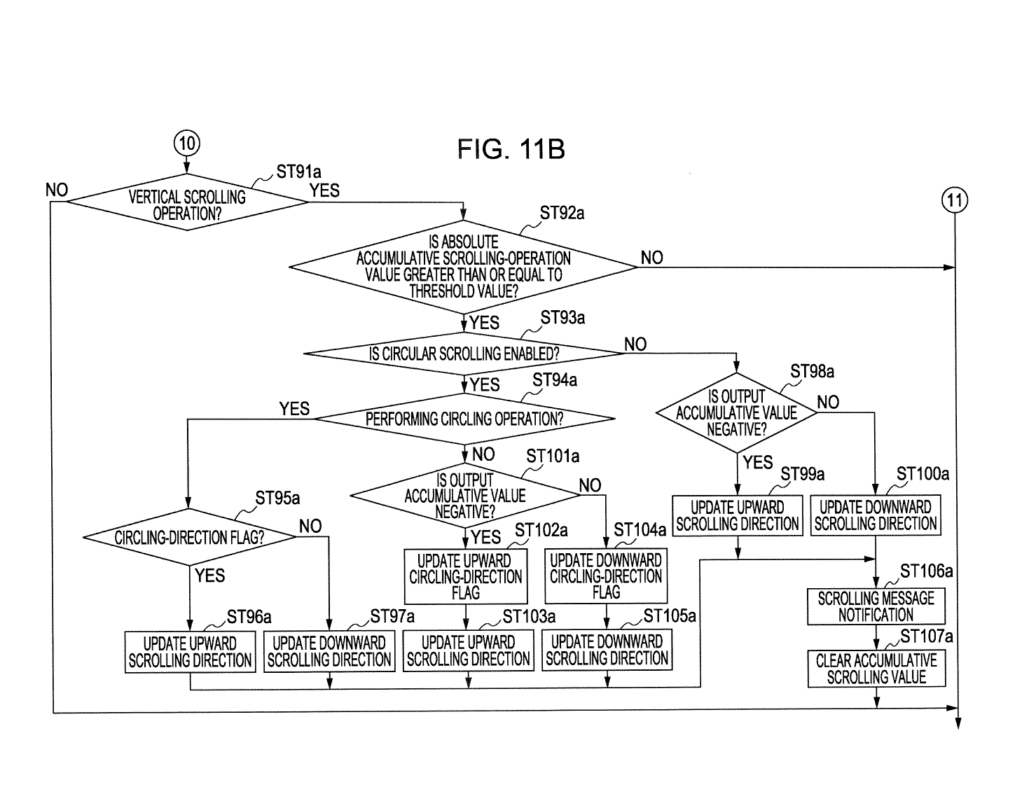

As shown in FIG. 11A, in step ST90 in the process flow V, the accumulative movement values for the vertical direction and the horizontal direction may be cleared. When it is determined that the finger contact position has started horizontal scrolling in the second function region 17 in step ST91, the process may proceed to step ST92 where it may be confirmed whether or not an accumulative movement value of the finger contact position is greater than a threshold value (distance Lx in FIG. 2). If the accumulative movement value is determined to be greater than the threshold value in step ST92, the process may proceed to step ST93 where it may be determined whether or not a flag that indicates that the finger contact posit on is in a curved path is set. When the flag is set and the finger is currently moving along the curved path in step ST94, the process may proceed to step ST95 where a scrolling-direction flag of the curved path may be confirmed. In steps ST96 and ST97, leftward scrolling or rightward scrolling of the displayed content may be continuously performed in accordance with the direction indicated by the scrolling-direction flag.

When it is determined in step ST93 that the finger contact position is not in a curved path, the process may proceed to step ST98 where it may be determined whether an accumulative value of an X-axis-direction movement path of the finger is a positive value or a negative value. In steps ST99 and ST100, the leftward scrolling or the rightward scrolling of the displayed content may be continuously performed in accordance with the positive-negative determination result.

If the finger contact position is not yet moved along the curved path in step ST95 regardless of the fact that the flag indicating that the finger contact position is in the curved path is set in step ST94, the process may proceeds to step ST101. At a point where an accumulative value of the curved path is obtained, a curved-path-direction flag may be updated in step ST102 or ST104 depending on whether the accumulative value is a positive or negative value. In step ST103 or ST105, the leftward scrolling or the rightward scrolling of the displayed content may be continuously performed depending on whether the accumulative value is a positive or negative value.

In step ST106, the operating system (OS) 22 may be notified of detection that the operation may be switched to a curved-path operation. In step ST107, an accumulative scrolling value may be updated, and the process may proceed to a step for waiting for subsequent detection output.

When it is determined in step ST91a in FIG. 11B that the finger contact position has started vertical scrolling in the first function region 16, the process may proceed to steps ST92a to ST107a. Steps ST92a to ST107a are steps for determining whether the scrolling direction is upward or downward on the basis of the curved path of the finger contact position and are similar to steps ST92 to ST107 except for that the directions, i.e., the horizontal direction and the vertical direction, are different.

After the process flow V in FIG. 4, the input determiner 24 may send an operation signal to the operating system (OS) 22 in step ST110.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

1. An input processing device comprising:
an input member having an input pad and a detector that detects a position of the input pad with which an indicator comes into contact; and
a controller that changes displayed content displayed on a display device on the basis of an input signal obtained from the input member,
wherein the controller performs
a first process of determining whether a contact position with which the indicator is in contact is in a preliminarily set function region in the input pad based on the input signal,
a second process of executing display movement processing for moving the displayed content when the contact position of the indicator is detected to be moving in an enabling direction for enabling processing within the function region, and
a third process of causing the display movement processing to be continuously performed when the controller determines that the contact position of the indicator is moved by a certain distance or more in the enabling direction within the function region and is subsequently moved continuously to a curved path continuing in one direction.

2. The input processing device according to claim 1, wherein the function region is a vertically long region extending vertically in the input pad, and
wherein the second process includes performing the display movement processing for moving the displayed content in one of an upward direction and a downward direction when the contact position of the indicator is moved in the downward direction, which is the enabling direction, within the vertically long region, and includes performing the display movement processing for moving the displayed content in the other one of the upward direction and the downward direction when the contact position of the indicator is moved in the upward direction, which is the enabling direction.

3. The input processing device according to claim 2, wherein a continuing process of the third process includes causing the displayed content to be moved continuously in the one direction when the contact position of the indicator is moved by a certain distance or more in the downward direction and is subsequently moved to a clockwise curved path within the vertically long region, and includes causing the displayed content to be moved continuously in the other direction when the contact position of the indicator is moved by a certain distance or more in the upward direction and is subsequently moved to a counterclockwise curved path.

4. The input processing device according to claim 1, wherein the function region is a horizontally long region extending horizontally in the input pad, and
wherein the second process includes performing the display movement processing for moving the displayed content in one of a rightward direction and a leftward direction when the contact position of the indicator is moved in the rightward direction, which is the enabling direction, within the horizontally long region, and includes performing the display movement processing for moving the displayed content in the other one of the rightward direction and the leftward direction when the contact position of the indicator is moved in the leftward direction, which is the enabling direction.

5. The input processing device according to claim 4, wherein a continuing process of the third process includes causing the displayed content to be moved continuously in the one direction when the contact position of the indicator is moved by a certain distance or more in the rightward direction and is subsequently moved to a counterclockwise curved path within the horizontally long region, and includes causing the displayed content to be moved continuously in the other direction when the contact position of the indicator is moved by a certain distance or more in the leftward direction and is subsequently moved to a clockwise curved path.

6. The input processing device according to claim 2, wherein a continuing process of the third process includes inverting the moving direction of the displayed content when the contact position of the indicator is changed continuously from a clockwise direction to a counterclockwise direction or from the counterclockwise direction to the clockwise direction.
